(19) United States
(12) Patent Application Publication
(10) Pub. No.: US 2024/0369259 A1
(43) Pub. Date: Nov. 7, 2024

(54) FOG GENERATOR FOR SECURITY SYSTEM

(71) Applicant: LIMITED LIABILITY COMPANY "G-MAK", S. HROMY (UA)

(72) Inventor: Volodymyr Mykolaiovych ROVINSKYI, Uman (UA)

(21) Appl. No.: 18/029,983

(22) PCT Filed: Feb. 16, 2023
(86) PCT No.: PCT/UA2023/000009

§ 371 Date: Apr. 3, 2023

(30) Foreign Application Priority Data
Jun. 6, 2022 (UA) A 2022 01894

(51) Int. Cl. F24H 1/12; F41H 9/06; G08B 15/02; H05B 1/02

(52) U.S. Cl. CPC F24H 1/122; H05B 1/0244; F41H 9/06; G08B 15/02

(57) ABSTRACT

The invention relates to the field of devices for artificial fog generation for use in security systems. A fog generator comprises an evaporator with an electrical heating element, a reservoir for a liquid to be evaporated, a pump and a programmable electronic control unit. A novel feature is that the electrical heating element is a coil winded by an additional winding, and a silica wrapping is arranged around rounds of the coil. To supply the liquid to be evaporated from the reservoir through the pump and to the evaporator, the device comprises: tubular connections, an additional reservoir, a general line, a needle-like tube having slots. The programmable electronic control unit comprises a microcontroller, transistor modules and units, sensors connected to other device elements. The fog generator enables to increase evaporation area, speed; to avoid the evaporator's excessive energy consumption in a standby mode; to reduce device weight and sizes.

The invention relates to a fog generator for a security system. This device is used in various rooms, vehicles, other locations in order to generate a certain amount of a fog which is safe for humans, when an unauthorized person has illegally entered the room or another restricted area. The quickly generated fog must disorient this person for a certain period of time with no harm to the human health. The invention is the fog generator for the security system.

### PRIOR ART

Fog generators for security systems are directly intended to generate a significant amount of the fog, when a person has illegally entered a room or another restricted area (e.g., a vehicle). Main current requirements as to these devices include: a safety of the fog, the fog generation speed, a sufficiently high amount and a density of the fog. Also, important characteristics include a compactness (a portability) of the device and its ability to “cooperate” with other electronic devices in terms of management and servicing the fog generator. The fog is obtained by evaporating a certain liquid mixture (preferably, a glycerol-based mixture), preferably, on surfaces of electrical heating elements (evaporators) which a power supply is connected to and which are energized. Problems of the most widely known structures include:
a large size, since the evaporator must have a large area in order to obtain the required high amount of the fog;
a necessity of a continuous powering in order to pre-heat the evaporators, thus, powerful and valuable power sources are required;
an excessive power consumption;
a difficulty or impossibility to generate the fog quickly (during a minimum time period after an “actuation” event);
a lack of a cost-effective and reasonable consumption of the liquid to be evaporated.

A fog machine is known, the machine comprises at least: one evaporator that is configured to evaporate a liquid, a main reservoir for the liquid to be evaporated, the main reservoir is connected to the evaporated so as to enable supplying of the liquid to be evaporated from the main reservoir to the evaporator, and a programmable electronic control unit (Invention patent U.S. Pat. No. 10,981,079 B1, IPC A63J5/00, A63J5/02, F41H9/06, publ. on 20.04.2021 [1]). This fog machine operates by evaporating a glycerol or glycol mixture and it is intended to generate an artificial fog/smoke for an entertainment use, for use in making special theatrical effects, for fire and tactical training, and for other applications. Said device has rather large dimensions, requires powerful and valuable power sources, and in view of its structural characteristics, this fog machine cannot be used as a portable fog generator for security systems.

A fog-generating device is known, the device comprises at least a heating means (an evaporator) that is configured to evaporate a liquid and that contacts with the liquid to be evaporated, as well as it comprises a reservoir for the liquid to be evaporated (European patent No. EP 3685362 B1, IPC G08B15/02, F41H9/06, publ. on. 29.12.2021, Bul. 2021/52 [2]). Said invention is a fog generator that is configured to generate a maximum dense fog in order to increase a security level of an alarm system. This structure and its operation are based on a principle of accumulation and long-term storage of a thermal energy on a significant number of thermally active metal plates (heat exchanging evaporators). However, this solution does not enable to avoid a preliminary continuous (stationary) warm-up of the “evaporator”, and, thus, it provides an excessive energy consumption by the “heat exchanging evaporators” in a standby mode. Furthermore, the structure of this fog-generating device is not small-sized and portable.

A technical solution that is the closest to the claimed invention is a fog generation device that is described in the invention “Device for generating fog and operating method of such device” and comprises: at least one evaporator 2 that is configured to evaporate a liquid (f) and that is formed by at least one electrical heating element 3 that contacts with the liquid (f) to be evaporated, and having a power supply connected thereto, a main reservoir 4 for the liquid (f) to be evaporated; a pump 5 that is connected to the main reservoir 4 and to the evaporator 2 so as to pump the liquid (f) to be evaporated from the main reservoir 4 to the evaporator 2; a programmable electronic control unit 6 having a power connector 26 and a switching connector 27 for connecting to other external electronic devices (European invention patent No. EP 3443263 B1, IPC F22B1/28, F41H9/08, F41H9/06, publ. on 11.05.2022, Bul. 22/19 [3]). This existing device is intended to generate the fog and is configured to operate by calculating a difference between electrical potentials in order to provide a thermal control of the pressurized liquid before evaporation of the same pressurized liquid. Also, this device is:
configured to operate continuously even in case of interruption of an electrical current;
capable of increasing a waiting time of the fog generation without supplying the electric energy;
capable of withdrawing its own need in the electric powering during pauses in the standby mode in order to save the electric energy.

A technical objective of the invention is to provide a cost-effective, lightweight, small-sized and portable fog generator that could be capable of providing a quick and a maximum evaporation effect of a certain liquid in order to generate a maximum amount of the fog, and that could be used on a standalone basis and/or as a part of complex security devices, systems which are used for security purposes within rooms and/or at other sites.

The technical effects which are achieved by the invention owing to all the essential features, including its novel features, are as follows:
increasing an effective evaporation area and, thus, increasing a speed of achievement of the evaporation effect and fog generation;
enabling a quick actuation of the device at a full capacity within 2-3 seconds after activation, and, thus, enabling generation of the required amount of the fog after activation as quickly as possible (without any preliminary continuous warm-up of the “evaporator”);
avoiding the preliminary continuous (stationary) warm-up of the “evaporator”, and, thus, avoiding an excessive energy consumption by the “evaporator” in the standby mode;
providing a small size (weight and overall dimensions) of the device;
increasing the fog generation speed and efficiency, while at the same time providing the energy saving and portability of the device, as a result of all the above-mentioned.

### SUMMARY OF THE INVENTION

The objective is achieved by a fog generator 1 comprising at least one evaporator 2 that is configured to evaporate a liquid (f) and that is formed by at least one electrical heating element 3 that contacts with the liquid (f) to be evaporated, and having a power supply connected thereto, a main reservoir 4 for the liquid (f) to be evaporated; a pump 5 that is connected to the main reservoir 4 and to the evaporator 2 so as to pump the liquid (f) to be evaporated from the main reservoir 4 to the evaporator 2, a programmable electronic control unit 6 having a power connector 26 and a switching connector 27 for connecting to other external electronic devices. A novel feature is that the at least one electrical heating element 3 is formed as at least one main coil 7 made of a metal wire 8, the coil is winded with an additional winding 9 made of an additional metal wire 10, and the electrical heating element 3 formed by the metal wire 8 and the additional metal wire 10 in the form of the main coil 7 having the additional winding 9 is thermally treated. A silica wrapping 13 that is made of a fireproof silica filament 14 is arranged around rounds of the coil 7 having the additional winding 9. The evaporator 2 comprises a needle-like tube 11 for supplying the liquid (f) to be evaporated, the needle-like tube is cylindrically shaped and comprises a clogged hole on one side and an open hole 16 on another side, and the needle-like tube 11 comprises transverse slots 12. A total sum of areas of all transverse slots 12 equals to an area of the open hole 16 of the needle-like tube 11. A portion of the needle-like tube 11 is inserted inside the main coil 7 of the electrical heating element 3 with that portion of the needle-like tube 11 which has the transverse slots 12 and the clogged hole. The fog generator 1 comprises a general line 15 having an inner pathway hole 17 for supplying the liquid (f) to be evaporated. The needle-like tube 11 is inserted with its side provided with the open hole 16 into the general line 15 in such a way that the open hole 16 of the needle-like tube 11 is connected to the inner pathway hole 17 of the general line 15, and an inlet of the pathway hole 17 of the general line 15 is connected to the pump 5. Furthermore, an additional reservoir 20 for a remainder of the liquid (f) to be evaporated is mounted under the evaporator 2 and over the main reservoir 4, the additional reservoir is connected to the pump 5, and the additional reservoir 20 and the main reservoir 4 are connected between each other by their own corresponding holes 22 and 23, while a tube 24 that is connected to the additional reservoir 20 is mounted inside the main reservoir 4. An air turbine 34 is mounted in front of the electrical heating element 3 of the evaporator 2. The programmable electronic control unit 6 comprises: a microcontroller 25 having an uploaded and installed software in a form of a data and source codes, a transistor module 28 for controlling the evaporator 2 powering and operation, a transistor unit 29 for controlling the pump 5 powering and operation, a transistor unit 30 for controlling the air turbine 34 powering and operation. Also, the fog generator 1 comprises a fog sensor 31 and a sensor 32 of the liquid (f) to be evaporated, while the evaporator 2 comprises a temperature sensor 33. The microcontroller 25 has established connections to the evaporator 2 via the transistor module 28, to the pump 5 via the transistor unit 29, to the air turbine 34 via the transistor unit 30, to the fog sensor 31, to the sensor 32 of the liquid (f) to be evaporated and to the temperature sensor 33 of the evaporator 2.

In some specific conditions, embodiments and applications of the inventive structure, the proposed fog generator is characterized by the following features, which develop, specify a set of features provided in independent claim.

The fog generator 1 comprises a plurality of evaporators 2, each formed by a corresponding heating element 3, each having a power supply connected thereto, and each one of the evaporators 2 comprises its own individual temperature sensor 33.

The fog generator 1 comprises four evaporators 2, each formed by a corresponding electrical heating element 3, and the four electrical heating elements 3, in particular, their main coils 7 along with the additional winding 9, are connected pairwise in parallel and then successively or completely successively, or completely in parallel, and the power supply is connected to each of the electrical heating elements 3.

The metal wire 8 of the main coil 7 and the additional metal wire 10 of the additional winding 9 are made of a nichrome alloy, and a diameter of the metal wires 8, 10 is ranged from 0.05 mm to 1.00 mm, while a diameter of the rounds of the main coil 7 is ranged from 3 mm to 3.5 mm, and a number of the rounds of the main coil 7 is ranged from seven to twelve.

Each electrical heating element 3 is made in a form of two or three main coils 7 which are adjacent and arranged “in a row” in parallel, and these parallel main coils 7 has a shared additional winding 9 provided by the additional metal wire 10 such that this electrical heating element 3 has a general “planar” shape.

Each electrical heating element 3 is made in a form of four or more main coils 7, and this plurality of the main coils 7 has a shared additional winding 9 provided by the additional metal wire 10.

The additional winding 9 of the main coil 7 or of the plurality of the main coils 7 is formed by a plurality of additional metal wires 10.

The needle-type tube 11 is made of a stainless steel and has a diameter ranged from 2 mm to 3 mm with a thickness of walls being 0.3 mm, and comprises from 12 to 20 transverse slots 12.

The fireproof silica filament 14 has a diameter ranged from 0.2 mm to 0.5 mm and is arranged in the silica wrapping 13 in an unsystematic fashion, or the fireproof silica filament 14 is arranged in the silica wrapping 13 perpendicularly relative to the rounds of the main coil 7.

The general line 15 for supplying the liquid (f) to be evaporated is made of a metal or a metal alloy, as well as mountable in the general line 15 and configured to enable a connection of a plurality of needle-like tubes 11 of the plurality of the corresponding evaporators 2 to its inner pathway hole 17.

The inlet of the pathway hole 17 of the general line 15 is connected to an inlet tube 18 having one side that is connected to a flexible tube 19 which is, in turn, connected to the pump 5, and the inlet tube 18 of the general line 15 is made of a metal or a metal alloy and has a diameter ranged from 3 mm to 4 mm, while the flexible tube 19 is made of a material that is able to withstand a high pressure and a high temperature of at least 220° C.

The fog generator 1 comprises an exhaust 35 that is mounted and arranged adjacent to the air turbine 34.

The microcontroller 25 has established connections to the plurality of the evaporators 2 via the transistor module 28 and has established connections to the corresponding temperature sensors 33.

### Inventive Step

The operation principle of the proposed structure of the fog generator 1 for the security system is based on a method for providing a flow-through supply of the liquid (f) to be evaporated to the interior of the heated evaporator 2 and to its electrical heating element 3. A based of this electrical heating element 3 is at least one main coil 7 that is made of the metal wire 8 having the diameter ranged from 0.05 mm to 1.00 mm, and this main coil 7 is further winded with the additional winding 9 that is made of the metal wire 10 having the diameter ranged from 0.05 mm to 1.00 mm. Preferably (in separate embodiments of the invention), the metal wire 8 of the main coil 7 and the metal wire 10 of the additional winding 9 are made of a nichrome alloy. Thus, materials for the metal wires 8 and 10 may vary depending on their specific resistance such that a sum of parameters of the diameters, winding type and values of the specific resistance could provide a resistance of the coils and their power which could be withstood by an overall circuit. Therewith, the diameter of the main coil 7 may be ranged from 3 mm to 3.5 mm, and the number of the rounds of the main coil 7 may be ranged from seven to twelve. In view of the fact that the metal wire 8 of the main coil 7 is thicker (in terms of diameter) than the metal wire 10 of the additional winding 9, the rounds of the main coil 7 are winded (“stacked”) in a sufficiently dense fashion between each other, and the rounds of the additional winding 9 are otherwise winded with the thinner metal wire 10 over the rounds of the main coil 7 in a less dense fashion between each other, i.e., with certain gaps between the rounds of the additional winding 9 and with open areas of the rounds of the metal wire 8 of the main coil 7. This results in formation of a base of the structure of the electrical heating element 3 in a form of a large number of the double-winded metal rounds having a large heating and evaporation area.

The main coil 7 and the additional winding 9 of the electrical heating element 3 are connected to the power source, and the metal wire 8 (of the main coil 7) and the metal wire 10 (of the additional winding 9), respectively, contact the liquid (f) to be evaporated.

According to the invention, after the additional winding 9 is winded onto the main coil 7, the formed base of the structure of the electrical heating element 3 is thermally treated at the temperature of at least 400° C. (it is “roasted”, e.g., by a gas soldering iron or by an electrical current supplying method, thereby bringing it to a roasting temperature). This high-heat treatment enables to form an electrically non-conductive scale-like layer on the metal wire 8 (of the main coil 7) and on the metal wire 10 (of the additional winding 9), and the layer provides this structure with significant dielectric properties, thereby avoiding inter-round short circuits of the metal wire 8 of the main coil 7 and the metal wire 10 of the additional winding 9 in the operation mode, when the electrical current passes through them.

This structure of the electrical heating element 3, due to the main coil 7 made of the metal wire 8 having the greater diameter and to the additional winding 9 made of the metal wire 10 having the smaller diameter, as well as due to the electrically non-conductive layer of these elements (that is formed as a result of the thermal treatment), enables to achieve the high area of the evaporation of the liquid (f) to be evaporated and the high specific heating power, while at the same time avoiding inter-round short circuits when the electrical current passes through them.

In separate embodiments of the invention, the electrical heating element 3 may be formed of two or three main coils 7 which are adjacent and arranged “in a row” in parallel in these cases. Therefore, these two or three parallel main coils 7 have the shared additional winding 9 provided by the additional metal wire 10 such that this electrical heating element 3 generally has the “planar” shape. In the same way, each electrical heating element 3 may be made in a form of four or more main coils 7 (e.g., five, six, seven, eight and more main coils 7), and this plurality of the main coils 7 also has the shared additional winding 9 provided by the additional metal wire 10. Furthermore, in separate embodiments of the invention, the additional winding 9 of the one or more main coils 7 may be formed by the plurality of the additional metal wires 10.

This structural design and winding (and, in individual cases, the mutual arrangement) of the main coils 7 and the additional windings 9, an overall surface area of each electric heating element 3 of each evaporator 2 is increased by 2-6 times (and even more), while at the same time, owing to the structure of the electric heating element 3 and the formation of the electrically non-conductive layers (as a result of the thermal treatment of the main coils 7 and the additional windings 9), it is enabled to maintain the resistance required for the voltage. The possibility of increasing the overall surface area of each electrical heating element 3 and a variability thereof enables: firstly, to create devices having different power, secondly, to increase or to reduce an amount and a speed of the liquid (f) to be evaporated at a required time, respectively, in different devices (having different number of the main coils 7 and the additional windings 9).

The fog generator 1 comprises the general line 15 having the inner pathway hole 17 for supplying the liquid (f) to be evaporated, and the at least one evaporator 2 is connected to the inner pathway hole. In separate embodiments of the invention, the structure of the supplying line 15 is made so as to enable to mount and to connect the plurality of the evaporators 2 to the inner pathway hole 17, each evaporator being formed by the corresponding electrical heating element 3. The general line 15 may be made of a metal or a metal alloy. In the most preferable embodiment of the invention that provides the plurality of the evaporators 2, the fog generator comprises four evaporators 2, each is formed by the corresponding electrical heating element 3. In this case, the four electrical heating elements 3, in particular, their main coils 7 along with the additional winding 9, may be connected between each other in various ways, e.g.: pairwise in parallel and then successively or completely successively, or completely in parallel. Thus, the power supply is connected to each electrical heating element 3.

Thus, the proposed base of the structure of the electrical heating element 3 which is formed by the main coil 7 with the additional winding 9, the presence and the structure of the supplying line 15 that enables to use from one to three electrical heating elements 3 within the same fog generator, allows to achieve a part of the technical effect, i.e., to increase the effective evaporation area (in certain cases, to increase it by up to 10-12 times as compared to usual existing single-winding coils) and, thus, to increase the efficiency and speed of achievement of the evaporation effect and generation of the fog.

According to the invention, the evaporator 2 comprises the needle-like tube 11 for supplying the liquid (f) to be evaporated. The needle-like tube 11 is cylindrically shaped and comprises:
the clogged hole on one side;
the open hole 16 on another side;
from 12 to 20 transverse slots 12 which are preferably arranged in a lower portion of the needle-like tube 11.

In separate embodiments of the invention, the needle-like tube 11 may be made of a stainless steel (in order to provide a chemical passivity of the liquid (f) to be evaporated with the structure) and it may have the diameter of from 2 mm to 3 mm with a thickness of walls being 0.3 mm.

The essential feature of the invention is that the maximum possible total sum of areas of all slots 12 equals to the area of the open hole 16 of the needle-like tube 11. This technical feature is caused by the following conditions:
if the sum of areas of the holes of all the slots 12 is greater than the area of the open hole 16 of the needle-like tube 11, then the liquid (f) to be evaporated, naturally, will flow out unevenly not through all the slots 12, but through several slots which are the “most convenient” for the liquid (f) to be evaporated (due to a certain low pressure/resistance inside the needle-like tube 11);
if the sum of areas of the holes of all the slots 12 is smaller than the area of the open hole 16 of the needle-like tube 11, then, due to a certain high pressure/resistance inside the needle-like tube 11, the liquid (f) to be evaporated will clog the slots 12 and, thus, the liquid (f) to be evaporated will also flow out unevenly through a portion of an unclogged slot 12. Therefore, the presence, the certain arrangement of the slots 12 and the sum of the areas of the holes of all the slots 12 represent an important technical feature that affects the “uniformity” of supplying the liquid (f) to be evaporated from the needle-like tube 11 to the main coil 7 with the additional winding 9 which, in turn, affects the efficiency and speed of the operation of the entire electrical heating element 3 of the evaporator 2 during the fog generation.

One side of the needle-like tube 11 is inserted inside the open hole 16 of the main coil 7 of the electrical heating element 3 such that the rounds of the main coil 7 entwine that portion of the needle-like tube 11 which is provided with the transverse slots 12. Another side of the needle-like tube 11 (the side of its own open hole 16) is inserted into the general line 15 such that the open hole 16 of the needle-like tube 11 is connected to the inner pathway hole 17 of the general line 15. The input of the pathway hole 17 of the general line 15 is connected to the inlet tube 18, while another side of the inlet tube is connected to the flexible tube 19 which is, in turn, connected to the pump 5. The inlet tube 18 may be made of the metal or metal alloy and it may have the diameter ranged from 3 mm to 4 mm, while the flexible tube 19, according to preferable embodiments, is made of the material that is able to withstand the high pressure and the high temperature of at least 220° C. Thus, the liquid (f) to be evaporated reaches the pathway hole 17 along the tubes 18, 19 under action of the pump 5, and then the liquid reaches the interior of the needle-like tube 11 from the pathway hole 17 of the general line 15, and then the liquid (f) to be evaporated, by passing through the slots 12, reaches the main coil 7 with the additional winding 9, where the liquid (f) to be evaporated is heated and the fog is generated.

The portion of the needle-like tube 11 that is provided with the slots 12 is inserted and arranged between the rounds of the main coil 7.

The main coil 7 with the additional winding 9 comprises the silica wrapping 13 that wraps said coil 7 and additional winding 9 during manufacture of the device before the portion of the needle-like tube 11 is inserted inside the hope of the main coil 7. The silica wrapping 13 may be made (woven, knit) of the silica filament 14 having the diameter ranged from 0.2 mm to 0.5 mm, and the silica filament 14 is arranged in the unsystematic fashion, or such that the rounds of the wrapping of the silica filament 14 are arranged approximately perpendicularly relative to the rounds of the main coil 7. That is, the wrapping rounds of the silica filament 14 are arranged approximately perpendicularly (or in the unsystematic fashion) relative to the rounds of the main coil 7 and around these rounds such that the wrapping rounds of the silica filament 14 are arranged both outside and inside the main coil 7 (while being in a partial contact with the walls of the needle-like tube 11). The silica filament 14 has fireproof properties—it withstands the temperature of up to 1100° C. (thereby avoiding its ignition/combustion when overheated). The formed silica wrapping 13, during the device operation, facilitates a uniform distribution of the liquid (f) to be evaporated on fog-evaporating surfaces of the main coil 7, on the additional winding 9 and on the walls of the needle-like tube 11.

The liquid (f) to be evaporated that reaches the interior of the needle-like tube 11 and then through the slots 12 (before getting on the main coil 7) also gets on the walls of the needle-like tube 11, as well as it gets on those filaments 14 of the silica wrapping 13 which are arranged inside the main coil 7. Then, the liquid (f) to be evaporated also gets on the main coil 7, on the additional winding 9 and on those filaments 14 of the silica wrapping 13 which are arranged outside the main coil 7. Physical properties of the liquid (f) to be evaporated (e.g., a mixture of glycerol, propylene glycol and water), the structure of the filaments 14 and their arrangement within the silica wrapping 13 facilitate “spraying” of the liquid (f) to be evaporated (under the pressure exerted by the pump 5) and its uniform distribution on the fog-evaporating surfaces of the main coil 7, on the additional winding 9 and on the walls of the needle-like tube 11. In such a way, the silica wrapping 13 acts as a “supplier-conductor” of the liquid (f) to be evaporated in the system of the electrical heating element 3. The hygroscopic liquid (f) to be evaporated, due to its own physical properties, naturally “adheres” to the filaments 14 of the silica wrapping 13 which results in a capillary motion action of the liquid (f) to be evaporated along fibres of the filaments 14 of the silica wrapping 13. At the same time, the filaments 14 of the silica wrapping 13 are also heated by contacting with the heated main coil 7 and the additional winding 9 up to the temperature of approximately 220° C., and, thus, the silica wrapping 13 also operates partially as the additional evaporator in combination with the main coil 7 and the additional winding 9. Due to the presence and the operation of the silica wrapping 13, the liquid (f) to be evaporated, after it is pumped by the pump 5, remains for a certain time within this system “the walls of the needle-like tube 11—the silica wrapping 13 inside the main coil 7—the main coil 7 with the additional winding 9—the silica wrapping 13 outside the main coil 7—the main coil 7 with the additional winding 9”, while after the liquid (f) is fully evaporated and its remainder is flowed naturally, a space for a new liquid (f) to be evaporated will be released in this system.

Therefore, at least one evaporator 2 (or each of the plurality of the evaporators 2) that is formed (are formed) by the corresponding electrical heating element 3 that is, in turn, formed by the hollow needle-like tube 11 having the slots 12, by the main coil 7 that is winded by the additional winding 9 and by the silica wrapping 13 that is arranged (wrapped) around the rounds of the main coil 7 with the additional winding 9. Therewith, the power is supplied to the main coil 7 and to the additional winding 9. This complex structure of the evaporator 2 enables to:
achieve the quick and uniform supply of the liquid (f) to be evaporated to the main coil 7 and to the additional winding 9 (owing to the structure of the needle-like tube 11, slots 12, silica wrapping 13, as well as owing to the arrangement of the needle-like tube 11 between the rounds of the main coil 7);
increase the area of the effective evaporation (owing to the “doubleness” of the main coil 7 and the additional winding 9, and owing to the presence of the additional evaporator in the form of the silica wrapping 13), and, thus, to increase the speed of achievement of the evaporation effect and fog generation;
achieve small sizes (weight and overall dimensions) of the device owing to the presence of the large are of the main coil 7 and the additional winding 9 (in contrast to the existing similar devices which utilize rather large-sized brass or copper radiators).

The fog generator 1 comprises the main reservoir 4 for the liquid (f) to be evaporated and the additional reservoir 20 for the remainder of the liquid (f) to be evaporated, the additional reservoir is mounted under the evaporator 2 and over the main reservoir 4. These reservoirs 4 (the main one) and 20 (the additional one) are connected between each other by their own corresponding 22 and 23, and the tube 24 that is connected to the additional reservoir 20 is arranged inside the main reservoir 4. The additional reservoir 20 is connected to the pump 5, and this connection may be made, e.g., by means of the flexible tube 21. The presence, structural features, arrangement site and all the connections of the additional reservoir 20 during the operation of the device enable to “collect” the remaining mixture of the liquid (f) to be evaporated and to mix these hot residues with the initial liquid (f) to be evaporated already in the main reservoir 4 (this process is described in detail in the section “OPERATION OF THE DEVICE”). This mixture becomes more tenuous and easier to pump (in terms of both speed and energy), and, thus, this mixture is capable of being evaporated more easily and quickly on the surfaces of the main coil 7 and the additional winding 9 of the electrical heating elements 3, since this mixture is not cold anymore, rather it is partially “heated”. Therefore, the presence, structural features, arrangement site and all the connections of the additional reservoir 20 speed up the fog generation, while at the same time providing the power saving (owing to the re-use of the pre-heated mixture).

The air turbine 34 (e.g., a high-speed fan, but without limitation thereto) is mounted in front of the electrical heating element 3 of the evaporator 2 or in front of the plurality of the evaporators 3. The exhaust 35 may be mounted adjacent to the air turbine 34. Said elements are intended to form a powerful air flow to the electrical heating elements 3, where the fog is generated. In order to generate a thick fog, it is required to “stir” the fog with the air forcedly during the evaporation, while, at the same time, it is also required to create a condition of non-return of the liquid (f) to be evaporated which has been evaporated by condensation. The air turbine 34 is provided for this particular purpose. The operation of the air turbine 34 with the exhaust 35 is described in detail in the section “OPERATION OF THE DEVICE”. Therefore, the operation of the air turbine 34 with the exhaust 35 increases the efficiency of the fog generation having a certain thickness and provides the non-return of the liquid (f) to be evaporated back to the area of the electrical heating elements 3.

All elements of the fog generator 1 for the security system are structurally combined to form a single device. A “managing” base of the entire structure is the programmable electronic control unit 6 comprising the microcontroller 25 having the uploaded and installed software in a form of a data and source codes, and the plurality of transistor units and modules such as:
the transistor module 28 for controlling powering and operation of the evaporator 2 or the plurality of the evaporators 2;
the transistor unit 29 for controlling the pump 5 powering and operation;
the transistor unit 30 for controlling the air turbine 34 powering and operation.

Thus, the microcontroller 25 has established connections to the evaporator 2 (or to the plurality of the evaporators 2) via the transistor module 28, to the pump 5 via the transistor unit 29, and to the air turbine 34 via the transistor unit 30. The programmable electronic control unit 6 comprises the power connector 26 and the switching connector 27 for connecting to other external electronic devices. All the listed elements of the programmable electronic control unit 6 may be mounted, e.g., on a single electronic circuit board. Furthermore, the microcontroller 25 has established connections to the fog sensor 31, to the sensor 32 of the liquid (f) to be evaporated, and to the temperature sensor 33 of the evaporator 2 (or to the plurality of the temperature sensors 33 of the plurality of the evaporators 2).

The microcontroller 25 is connected, via the switching connector 27, to another external electronic device which is an “external control device” that activates the start of operation of the fog generator 1 (e.g., “a security system external module” or “a motion sensor along with a security system module”, or another similar “external control device”, which do not form the subject matter of the present invention and are not a part of the fog generator 1). At the required moment, the “external control device” provides a command about the start of the device operation to the microcontroller 25. Thus, when it is further required to generate the fog, the microcontroller 25 “provides commands”: to the pump 5 (via the transistor unit 29) to supply the liquid (f) to be evaporated to the evaporators 2 and a command to heat the electrical heating elements 3 of the evaporators 2. The pump 5 “picks up” the liquid (f) to be evaporated from the main reservoir 4 via the tube 24 (inside the main reservoir 4) and then via the additional reservoir 20. Then, the pump 5 guides the liquid (f) to be evaporated via the flexible tube 19 and via the inlet tube 18 to the inner pathway hole 17 of the general line 15. Under the action of pressure (that is provided by the pump 5), the liquid (f) to be evaporated is uniformly distributed in the inner pathway hole 17 of the general supply line 15 wherefrom (under the pressure provided by the pump 5) the liquid (f) to be evaporated gets inside the evaporator 2 or inside the plurality of the evaporators 2. At the same time, the microcontroller 25 (via the transistor module 28) “provides the heating command” to the electrical heating elements 3 of the evaporators 2. Thus, the corresponding electrical current is supplied to the main coils 7 and to the additional winding 9, while the power of the electrical current and the heating temperature of the coils are controlled and adjusted by the microcontroller 25. The liquid (f) to be evaporated is heated quickly (within 2-3 seconds) and to the full extent, and, thus, the fog is generated. The temperature sensors 33 control the temperature in the area of the evaporators 2 and transmit the corresponding signals to the microcontroller 25, thereby avoiding an overheating of the evaporators 2 (by PID-controlling of the actual power of the operation of the evaporators 2 between the microcontroller 25 and the transistor module 28, when the temperature exceeds allowable limits). The microcontroller 25 controls the operation and powering of the pump 5 via the transistor unit 29. The microcontroller 25 also controls the operation and powering of the air turbine 34 via the transistor unit 30. The sensors 31 and 32 provide the corresponding signals to the microcontroller 25 about: a presence of the fog in the device (the sensor 31) and a presence/level of the liquid (f) to be evaporated in the main reservoir 4 (the sensor 32).

Use of all the mentioned elements in the programmable electronic control unit 6, their arrangement, as well as a mutual connection between each other and to the corresponding mentioned sensors, enable to achieve the quick and effective control of the operation of the device, while providing, at the same time, effective and cost-effective power consumption. Therewith, modern electronic components enable to provide the portability of the device.

Therefore, the proposed structure of the fog generator 1 for the security system, originality and features of all its elements, their mutual arrangement and mutual connections between each other, enable to provide a cost-effective, lightweight, small-sized and portable fog generator that is capable of providing the quick and maximum evaporation effect for a certain liquid in order to generate a maximum amount of the fog, and that is intended to be used on a stand-alone basis and/or as a part of multi-component complex security devices, systems, which are used for security purposes within rooms and/or in other locations (e.g., in vehicles, but without limitation thereto).

The structure of the evaporator 2 in the form of the electrical heating element 3 that is formed as the main coil 7 which is winded by the additional winding 9 in combination with the needle-like tube 11 having the transverse slots 12 and the silica wrapping 13 directly provide the increased area of the effective evaporation (which is 10-12 times greater than the single-winding coils in the structures of the existing similar devices), and, thus, the speed of providing the evaporation effect and the fog generation is increased.

The electronic circuit board and the arrangement of the programmable electronic control unit 6, sensors 31, 32, 33 in combination with the structure of the evaporator 2, the general line 15, the main reservoir 4 and the additional reservoir 20, enable the quick actuation of the device with the full power within 2-3 seconds after activation, and, thus, it is enabled to generate the required amount of the fog after activation as quickly as possible (without any preliminary warm-up of the “evaporator” as it is performed in the most existing similar devices). That is, the structure of the fog generator 1 allows to omit the preliminary continuous (stationary) warm-up of the “evaporator”, and, thus, to omit the excessive power consumption by the “evaporator” in the standby mode (in contrast to the existing analogues, where the warm-up of the evaporator may be performed in advance during 15-40 minutes which requires additional 40-300 W to compensate the costs in the continuously warmed-up conversion convector).

The originality of the doubled coils (the main coil 7 with the additional winding 9) having the high evaporation area, as well as the possibility of their composing, enable to create and to use the small-sized evaporators 2 which have much lower dimensions, weight than certain existing large-sized evaporators in the form of copper/brass radiators.

Therefore, the structure of the proposed fog generator 1 enables to achieve the quick and efficient fog generation, while at the same time providing the energy saving and portability of the device, as a result of all the above-mentioned.

Practical implementation and industrial applicability of the fog generator is explained by schematic views of the structure, in which:

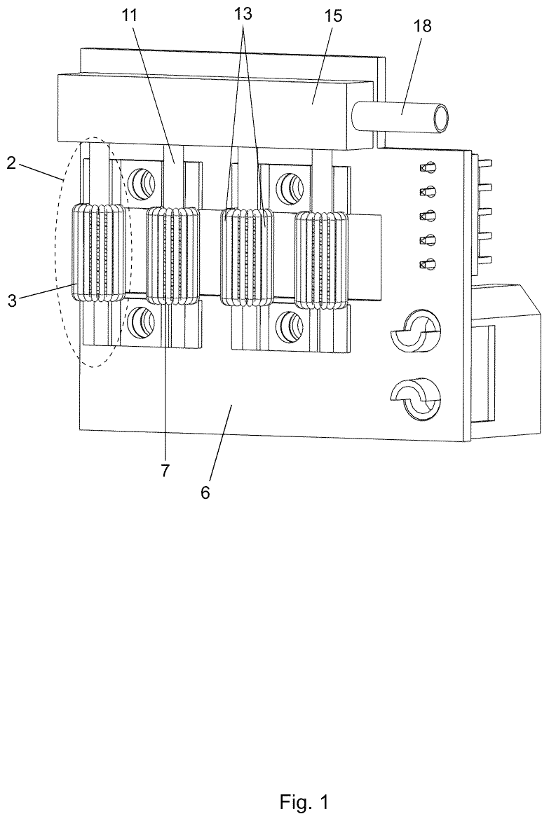

FIG. 1 depicts the fog generator 1 unit with the four evaporators 2 and the general line 15 for supplying the liquid (f) to be evaporated, while showing the silica wrapping 13 on the main coils 7 of the electrical heating elements 3;

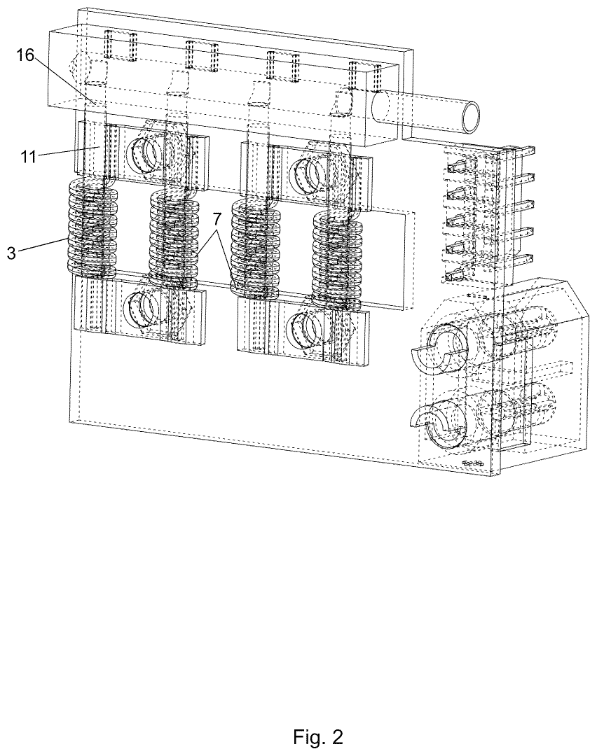

FIG. 2 depicts a 3D image of the fog generator 1 unit with the four evaporators 2, which shows: the main coils 7 of the electrical heating elements 3 without the silica wrapping 13; the general supply line 15, the inner pathway hole 17, the inlet tube 18, the needle-like tubes 11 with the open holes 16;

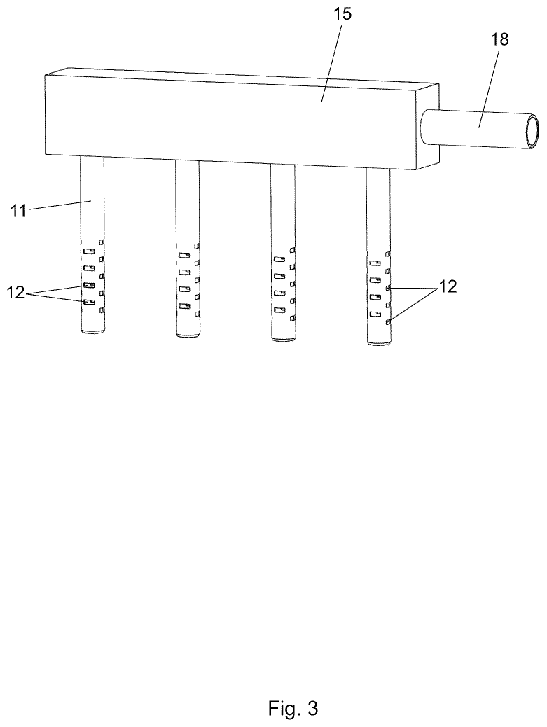

FIG. 3 depicts the general line 15 for supplying the liquid (f) to be evaporated with the four needle-like tubes 11 and with the transverse slots 12;

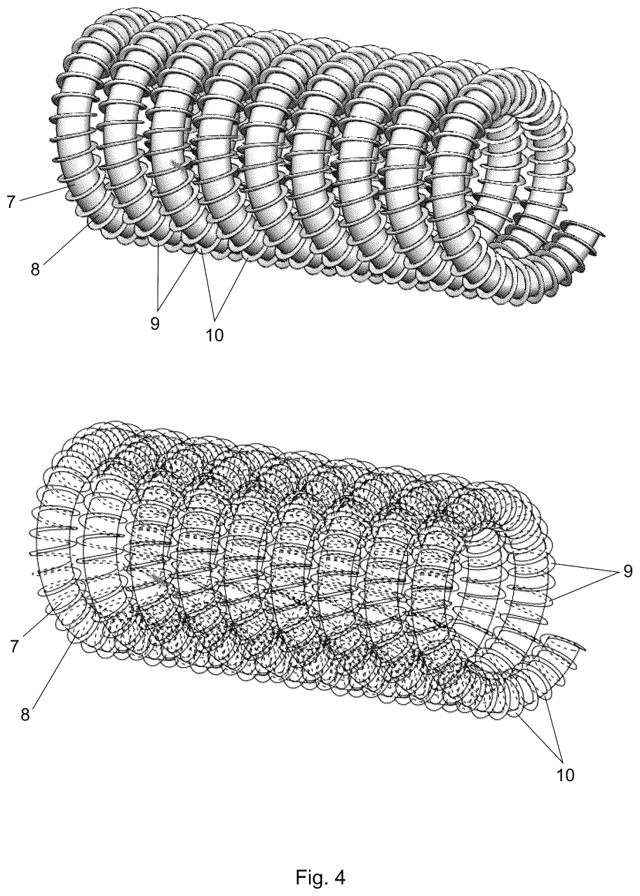

FIG. 4 depicts the main coil 7 made of the metal wire 8, the additional winding 9 made of the metal wire 10;

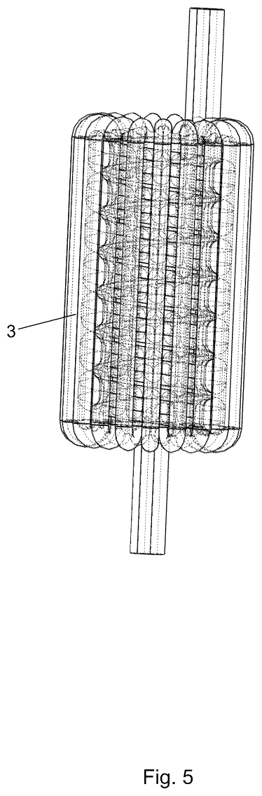

FIG. 5 depicts the silica wrapping 13 on the main coil 7;

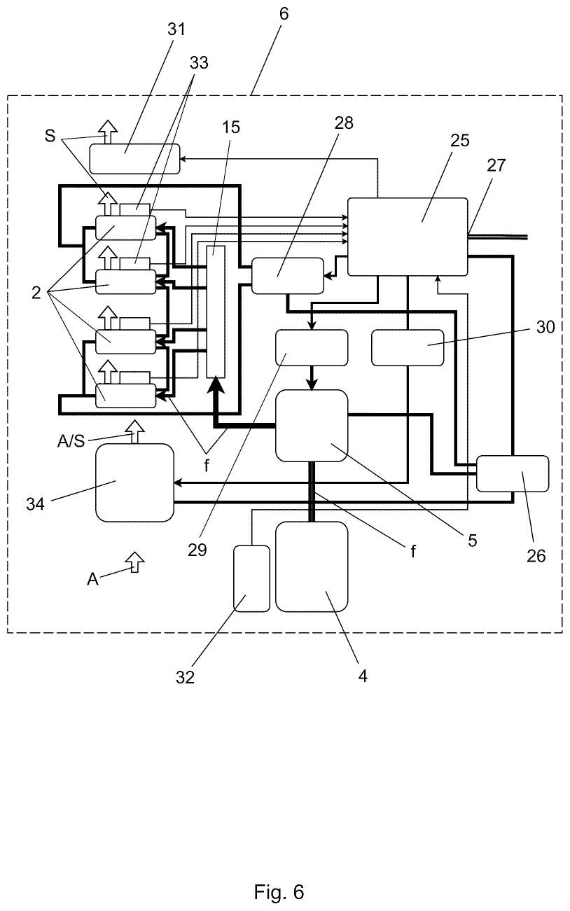

FIG. 6 depicts a block diagram of the structural and electronic elements of the fog generator 1 (showing the fog-S, the air movement-A, movements of the liquid (f) to be evaporated);

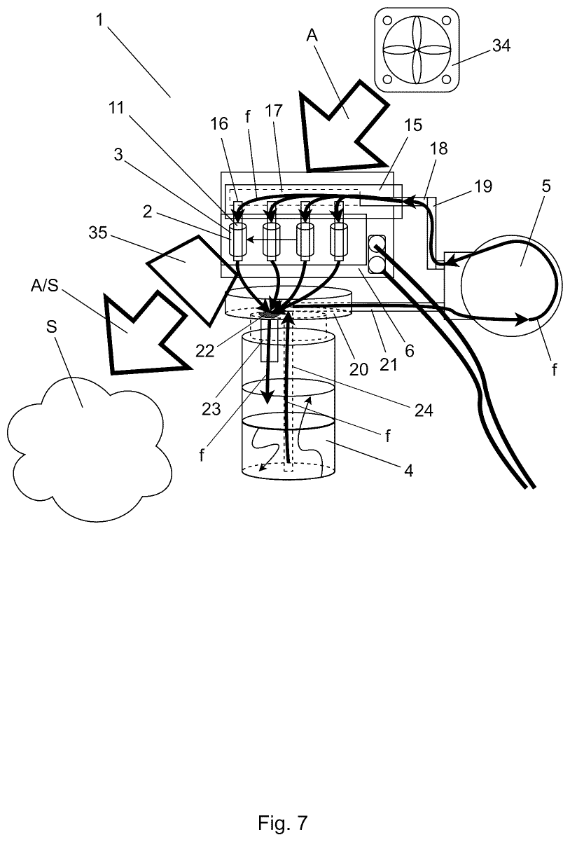

FIG. 7 depicts a schematic illustration of the structure and operation of the fog generator 1 with the four evaporators 2 (showing the fog-S, the air movement-A, movements of the liquid (f) to be evaporated).

Nomenclature, list of elements, assemblies, details of the invention structure.
1—the fog generator for the security system;
2—the evaporator;
3—the electrical heating element;
4—the main reservoir for the liquid (f) to be evaporated;
5—the pump;
6—the programmable electronic control unit;
7—the main coil of the electrical heating element 3;
8—the metal wire of the main coil 7;
9—the additional winding of the main coil 7;
10—the metal wire for the additional winding 9;
11—the needle—like tube for supplying the liquid (f) to be evaporated;
12—the transverse slots of the needle—like tube 11;
13—the silica wrapping;
14—the silica filament of the silica wrapping 13;
15—the general line for supplying the liquid (f) to be evaporated;
16—the open hole of the needle—type tube 11;
17—the inner pathway hole of the general line 15;
18—the inlet tube of the general line 15;
19—the flexible tube between the inlet tube 18 and the pump 5;
20—the additional reservoir for the remaining mixture of the liquid (f) to be
evaporated;
21—the flexible tube between the additional reservoir 20 and the pump 5;
22—the hole of the additional reservoir 20;
23—the hole of the main reservoir 4;
24—the tube inside the main reservoir 4;
25—the microcontroller;
26—the power connector;
27—the switching connector for connecting to other external electronic devices;
28—the transistor module (for example, a MOSFET module) for controlling the evaporator 2 powering and operation
29—the transistor unit (for example, a MOSFET module) for controlling the pump 5 powering and operation;
30—the transistor unit (for example, a MOSFET module) for controlling the air blower 34 powering and operation;
31—the fog sensor;
32—the sensor of the liquid (f) to be evaporated;
33—the temperature sensor of the evaporator 2;
34—the air turbine;
35—the exhaust;
36—the power supply bus of the evaporators 2;
f—the liquid to be evaporated (e.g., a mixture of glycerol, propylene glycol and water, but without limitation thereto);
S—the fog in FIGS. 6, 7;
A—the blown air in FIGS. 6, 7;
A/S—the air-fog mixture in FIGS. 6, 7.

### Description of the Structure

The fog generator 1 for the security system comprises at least one evaporator 2 that is formed of at least one electrical heating element 3 that contacts with the liquid (f) to be evaporated (FIG. 7, 1). The power supply is connected to the electrical heating element 3 (FIG. 6). In separate embodiments of the invention, the fog generator may comprise two, three, four (FIG. 1, 2, 6, 7) and more evaporators 2 which are formed by two, three, four and more corresponding electrical heating elements 3 (FIG. 7, 1), while each of them contacts with the liquid (f) to be evaporated and connected to the power supply. Thus, each evaporator 2 is configured to evaporate the liquid (f). The fog generator 1 further comprises the main reservoir 4 for the liquid (f) to be evaporated (FIG. 7, 6). The fog generator 1 comprises the pump 5 (FIGS. 6, 7) that is connected to the main reservoir 4 and to the evaporator 2 (or to the plurality of the evaporators 2) so as to pump the liquid (f) to be evaporated from the main reservoir 4 to the evaporator 2 or to the plurality of the evaporators 2. The fog generator 1 further comprises the programmable electronic control unit 6 (FIGS. 6, 1, 7) for controlling and adjusting the operation of the device.

According to the invention, the one electrical heating element 3 (or each of the plurality of the electrical heating elements 3) is made in the form of the main coil 7 that is, in turn, made of the metal wire 8 (FIG. 4) having the diameter that may range from 0.05 mm to 1.00 mm and a specific resistance of, e.g., greater than 0.35 Ohm×mm²/m, but without limitation thereto. This material of the metal wire 8 may be, e.g., a nichrome alloy or a similar metal or alloy. Preferably, the diameter of the main coil 7 is ranged from 3 mm to 5 mm, and the number of the rounds may range from seven to twelve rounds with a dense winding in a “round-to-round” fashion. Besides the main coil 7, the electrical heating element 3 comprises the additional winding 9 formed by the additional (preferably, a thinner one) metal wire 10 (FIG. 4) that may have the diameter ranged from 0.05 mm to 1.00 m. The additional metal wire 10 may be made, e.g., from a nichrome alloy or from another similar metal or alloy. That is, the main coil 7 is additionally winded by the thinner additional metal wire 10 and, thus, the electrical heating element 3 (or each of the plurality of the electrical heating elements 3) is formed by at least the main coil 7 of the metal wire 8 that is additionally winded by the additional thinner metal wire 10.

In separate embodiments of the invention, the at least one electrical heating element 3 (or each of the plurality of the electrical heating elements 3) may be made in the form of two or three main coils 7 which are adjacent and arranged “in a row” in parallel. These two or three parallel main coils 7 also have the shared additional winding 9 provided by the additional (thinner) metal wire 10 such that this electrical heating element 3 generally has the “planar” shape (not illustrated in the Figures). Furthermore, each electrical heating element 3 also may be made in the form of four or more main coils 7 which also have the shared additional winding 9 provided by the additional metal wire 10 (not illustrated in the Figures).

It should be noted that in separate embodiments of the invention, the additional winding 9 of the main coil 7 (or of the plurality of the main coils 7) may be formed not only by one, but by the plurality (e.g., by two or three and more) of the additional (thinner) metal wires 10 (not illustrated in the Figures).

Therefore, in separate embodiments of the invention, the electrical heating element 3 may be formed by the plurality (two or three, or more) of the main coils 7 which are additionally covered by one or two, or three additional (thinner) metal wires 10.

After the additional winding 9 is winded on the main coil 7, e.g., by means of a gas soldering iron (but without limitation thereto), the entire structure of the formed electrical heating element 3 is roasted up to the temperature of 400-500 degrees to form a scale (an electrically non-conductive layer) that provides this structure with dielectric properties in order to avoid inter-round short circuits during further use (during heating) of the electrical heating element 3 in the operation mode, when the electrical current passes through them.

The heating power of one electrical heating element 3 may be, e.g., 250 W. Thus, if in separate embodiments, the inventive structure possesses, e.g., four evaporators 2 with four corresponding electrical heating elements 3, then the total heating power may be up to 1000 W.

Each evaporator 2 comprises the needle-like tube 11 (FIGS. 1, 2, 3, 7) for supplying the liquid (f) to be evaporated. The needle-like tube 11 is cylindrically shaped and may be made of a stainless steel, has the diameter ranged from 2 mm to 3 mm and a thickness of the walls being approximately 0.3 mm, while the through hole on one side of the needle-like tube 11 is clogged and another side thereof has the open hole 16 (FIGS. 2, 7). The needle-like tube 11 comprises from 12 to 20 transverse slots 12 (holes) (FIG. 3). The total sum of areas of all the slots 12 equals to the area of the open hole 16 of the needle-like tube 11 to the greatest extent. As it has been already mentioned, this technical feature is caused by the following:
if the sum of areas of the holes of all the slots 12 is greater than the area of the open hole 16 of the needle-like tube 11, then the liquid (f) to be evaporated, naturally, will flow out unevenly only through several slots 12 which are the “most convenient” (due to certain low pressure/resistance inside the needle-like tube 11);
if the sum of the areas of the holes of all the slots 12 is smaller than the area of the open hole 16 of the needle-like tube 11, then the high pressure/resistance will be formed inside the needle-like tube 11, and the liquid (f) to be evaporated will form the clogging of the slots 12 and the liquid (f) to be evaporated will also flow out unevenly through the part of the non-clogged slots 12.

The needle-like tube 11 is inserted into the hole of the main coil 7 (FIG. 2) of the electrical heating element 3.

The main coil 7 with the additional winding 9 (before inserting the part of the needle-like tube 11 into the hole of the main coil 7) is wrapped by the silica wrapping 13 (FIGS. 1, 5) that has fireproof properties—it withstands the temperature of up to 1100° C. (thereby avoiding its ignition/combustion when overheated). In separate embodiments of the invention, the silica wrapping 13 may be made (woven, knit) of the silica filament 14 (FIG. 5) having the diameter ranged from 0.2 mm to 0.5 mm and the silica filament 14 is arranged in the unsystematic fashion. In other separate embodiments of the invention, the silica wrapping 13 may be made (woven, knit) such that the wrapping rounds of the silica filament 14 are arranged approximately perpendicularly relative to the rounds of the main coil 7. The silica wrapping 13 facilitates the uniform distribution of the liquid (f) to be evaporated on the fog-evaporating surfaces of the main coil 7 and the additional winding 9.

Therefore, at least one evaporator 2 or each of the plurality of the evaporators 2 is formed by the corresponding electrical heating element 3 that is, in turn, formed by the main coil 7, the additional winding 9, the silica wrapping 13 and the needle-like tube 11 having the slots 12.

The fog generator 1 comprises the general line 15 for supplying the liquid (f) to be evaporated, and the line may be made, e.g., of brass, but without limitation thereto (FIGS. 1, 2, 3, 6, 7). The inner pathway hole 17 for the liquid (f) to be evaporated is provided inside the general line 15 (FIGS. 2, 7). The needle-like tube 11 of the evaporator 2 or the plurality of the needle-like tubes 11 of the plurality of the evaporators 2 are sealingly inserted (with their open holes 16) into the general line 15 such that the open hole 16 of the needle-like tube 11 is connected to the inner pathway hole 17 of the general line 15 (FIGS. 2, 7). The inlet tube 18 is mounted at the inlet of the general line 15 (FIGS. 1, 2, 3, 7), the inlet tube may be made, e.g., of the stainless steel and have the diameter ranged from 3 mm to 4 mm, but without limitation thereto. The general line 15 is connected to the pump 5, and the connection may be provided in the following way: the flexible tube 19 is connected to the inlet tube 18 (FIG. 7), and the flexible tube is made of a material that is able to withstand a high temperature (at least 220° C.) as well as to withstand a high pressure. The pump 5 for pumping the liquid (f) to be evaporated is connected to the flexible tube 19 (e.g., a peristaltic pump, but without limitation thereto).

As it has been already mentioned in separate embodiments of the invention, the structure of the fog generator 1 may comprise two or three, or four evaporators 2 (but without limitation thereto), each is formed by the corresponding electrical heating element 3. As a description of the best exemplary embodiment of the invention, FIGS. 1, 2, 6, 7 illustrate the structure having four evaporators 2 and, thus, four electrical heating elements 3. Having this number of the evaporators 2, the four electrical heating elements 3 (in particular, their main coils 7 together with the additional winding 9), in various separate embodiments, may be connected in various configurations, including the following:
pairwise in parallel and then successively (type 2p2s);
completely successively (for a more high-voltage modification, type 4s);
completely in parallel (type 4p).

The fog generator 1 comprises the additional reservoir 20 (FIG. 7) for the remaining mixture of the liquid (f) to be evaporated (that has not evaporated completely), the additional reservoir is mounted under the evaporator 2 (or under the plurality of the evaporators 2) and connected to the pump 5, e.g., by means of the flexible tube 21. The main reservoir 4 for the liquid (f) to be evaporated is mounted under the additional reservoir 20. These reservoirs 20 (the additional one) and 4 (the main one) are connected between each other by their own corresponding openings 22 and 23 (FIG. 7) in order to enable the remaining mixture of the liquid (f) to be evaporated to reach the main reservoir 4 from the additional reservoir 20. The tube 24 is arranged inside the main reservoir 4 (FIG. 7), the tube is connected to the additional reservoir 20 in order to enable capturing (delivery) of the liquid (f) to be evaporated from the main reservoir 4 to the additional reservoir 20 and then to the pump 5.

The main reservoir 4 is made in the form of a replaceable “cartridge” and is filled with the liquid (f) to be evaporated. The liquid (f) to be evaporated is a mixture of glycerol and propylene glycol (taken in an approximate ratio of 70/30) with water (as well as certain preservatives in very low amounts). The liquid (f) to be evaporated does not cause any harmful consequences in case a human breathes it in or in case of a skin contact.

The fog generator 1 comprises the air turbine 34 (a blower or a high-revolution fan) that is mounted and arranged in front of the one or in front of the plurality of the electrical heating elements 3 of the evaporators 2 (FIG. 7). The air turbine 34 is intended to generate a powerful air flow. In order to achieve a maximum performance coefficient, the flow from the air turbine 34 towards the electrical heating elements 3 is generated by the special exhaust 35 that has smoothed shapes inside and guides the flow to the fog generation source directly. Also, the air turbine 34 and the exhaust 35 form a direction of the jet of the generated fog. The exhaust 35 is mounted and arranged adjacent to the air turbine 34 (the exhaust 35 is schematically illustrated in FIG. 7).

The fog generator 1 comprises the programmable electronic control unit 6 that is based on the microcontroller 25 (FIG. 6). The programmable electronic control unit 6 may be formed as an electronic circuit board and it comprises the power connector 26 (supplying the power voltage ranged from 9 to 25 Volts, e.g., from an accumulator, a battery, a power unit, a vehicle powering system, a stationary mains power, another power element). The microcontroller 25 comprises the switching connector 27 (FIG. 6) for connecting to other external electronic devices (e.g., to other microcontrollers). The connector 27 may be formed as, e.g., any stationary connectors of various USB type modifications to transmit data and power, but without limitation thereto. The programmable electronic control unit 6 further comprises: the transistor module 28 for controlling the evaporator 2 powering and operation, the transistor unit 29 for controlling the pump 5 powering and operation, the transistor unit 30 for controlling the air turbine 34 powering and operation (FIG. 6).

The fog generator 1 further comprises the fog sensor 31 and the sensor 32 of the liquid (f) to be evaporated (FIG. 6). Furthermore, the evaporator 2 comprises the temperature sensor 33 of the evaporator 2 (e.g., a thermistor). If the plurality of the evaporators 2 is provided, then each of the evaporators 2 comprises its own individual temperature sensor 33 (FIG. 6). The temperature sensor 33 is mounted adjacent to the main coil 7 of the electrical heating element 3 of the evaporator 2.

The microcontroller 25 has established connections to:
the evaporator 2 or to the plurality of the evaporators 2 via the transistor module 28 for controlling the powering and the operation of the evaporator(s) 2;
the pump 5 via the transistor unit 29 for controlling the pump 5 powering and operation;
the air turbine 34 via the transistor unit 30 for controlling the air turbine 34 powering and operation;
the fog sensor 31;
the sensor 32 of the liquid (f) to be evaporated;
the temperature sensor 33 of the evaporator 2 or to the plurality of the temperature sensors 33.

All electronic elements which require powering are connected to the power connector 26 or powered by the microcontroller 25.

The power supply contacts are connected to the electrical heating element 3 of the evaporator 2 or to the plurality of the electrical heating elements 3 of the plurality of the evaporators 2 by means of a “powerful” copper or brass bus 36 (FIG. 7) (for peak electrical currents of up to 100A).

The microcontroller 25 has the uploaded (installed) software in the form of data and source codes for controlling the operation of the fog generator 1 for the security system.

### Operation of the Device

In order to describe the operation of the fog generator 1 for the security system by providing the best example, the operation of the structure of the fog generator 1 that comprises four evaporators 2 (FIG. 7). This device utilizes a method for providing a flow-through supply of the liquid (f) to be evaporated to the interior of the heated evaporators 2 having the high evaporation area and the high specific power of the heating. The mixture based on glycerol, propylene glycol and water may be used as the liquid (f) to be evaporated (but without limitation thereto). In certain embodiments, this mixture may comprise preservatives. In order to provide the safe operation of the fog generator 1, the liquid (f) to be evaporated must have all the required usage certificates which confirm that it will not cause any harmful consequences in case a human breathes it in or in case of a skin contact.

The fog generator 1 operates as a security element or as a security system module. In order to activate (turn in) the device, the microcontroller 25 must be connected, via the switching connector 27, to another external electronic device which is an “external control device” for the fog generator 1, e.g., it may be “a security system module” or “a motion sensor along with a security system module”, or another external control device, which do not form the subject matter of the present invention and are not a part of the fog generator 1. At the required moment, this “external control device” provides a command about the activation of the device operation to the microcontroller 25.

At the moment when the device must generate the fog, the microcontroller 25 “provides commands”: to the pump 5 (via the transistor unit 29) to supply the liquid (f) to be evaporated to the evaporators 2 and a command to heat the electrical heating elements 3 of the evaporators 2.

The liquid (f) to be evaporated is supplied to the interior of each evaporator 2 (to the main coil 7 and to the additional winding 9 of the electrical heating element 3) under the action of pressure that is uniformly distributed by the general supply line 15 and generated by the pump 5. The liquid (f) to be evaporated is pumped by the peristaltic pump 5 having an adjustable supply rate, and a maximum pumping volume in a standard design is about 100 ml/min. The pump 5 “picks up” the liquid (f) to be evaporated from the main reservoir 4 via the tube 24 inside the main reservoir 4 and then via the additional reservoir 20, then the pump 5 guides the liquid (f) to be evaporated via the flexible tube 19 and via the inlet tube 18 to the inner pathway hole 17 of the general line 15. From the general line 15, the liquid (f) to be evaporated gets inside the evaporators 2 (FIG. 7).

At the same time, the microcontroller 25 (via the transistor module 28) “provides the heating command” to the electrical heating elements 3 of the evaporators 2. Thus, the corresponding electrical current is supplied to the main coils 7 and to the additional winding 9 of the main coils 7 (the power of the electrical current and, thus, the heating temperature of the coils are adjusted by the microcontroller 25). The overall heating power of the four electrical heating elements 3 is up to 1000 W. Then, the liquid (f) to be evaporated gets to the surfaces of the metal wire 8 of the main coil 7 and to the surfaces of the metal wire 10 of the additional winding 9 which together (due to the increased number of the rounds of the metal wire 8 and of the metal wire 10) have a high area of the effective evaporation. The liquid (f) to be evaporated is heated quickly (within 2-3 seconds) and to the full extent, and, thus, the fog is generated. According to the invention, each main coil 7 with its own additional winding 9 is “covered” by the silica wrapping 13 that facilitates the uniform distribution of the liquid (f) to be evaporated on the fog-evaporating surfaces of the main coil 7 and the additional winding 9 outside, and on the fog-evaporating surface of the part of the needle-like tube 11 (that is arranged inside the main coil 7) at the moments of heating and during pumping the liquid (f) to be evaporated through this thin needle-like tube 11 with the transverse slots 12.

During the operation of the device, the silica wrapping 13 acts as a “supplier-conductor” of the liquid (f) to be evaporated in the system of the electrical heating element 3. The hygroscopic liquid (f) to be evaporated naturally “adheres” to the filaments 14 of the silica wrapping 13 which results in a capillary motion action of the liquid (f) to be evaporated along fibres of the filaments 14 of the silica wrapping 13. Furthermore, the silica wrapping 13 is also heated by the heated main coil 7 and the additional winding 9 up to the temperature of approximately 220° C., and the silica wrapping 13 also operates partially as the evaporator in combination with the main coil 7 and the additional winding 9. Due to the presence and the operation of the silica wrapping 13, the liquid (f) to be evaporated (after it is pumped by the pump 5) remains for a certain time within the system “the main coil 7 with the additional winding 9—the silica wrapping 13—the main coil 7 with the additional winding 9”, while after the liquid (f) is evaporated, a space for a new liquid (f) to be evaporated will be released in this system. The heated liquid (f) to be evaporated becomes tenuous, and the excessive heated and more liquid mixture of the liquid (f) to be evaporated that has not evaporated drips from the electrical heating element 3 to the additional reservoir 20 (FIG. 7) for the remainder of the liquid (f) to be evaporated, wherefrom the remainder of the liquid (f) to be evaporated, through the opening 23 of the main reservoir 4 and due to generation of the negative pressure in the main reservoir 4, naturally gets (is absorbed) again to a cavity of the main reservoir 4 (FIG. 7), where the hot liquid (f) to be evaporated is then mixed with the initial liquid (f) to be evaporated, and this mixture becomes more tenuous, i.e., it becomes easier for pumping (in terms of both speed and energy), and, thus, when it gets the electrical heating elements 3 of the evaporators 2 again, this mixture of the liquid (f) to be evaporated can be evaporated easier and quicker, since it is not cold yet, rather it is partially “warmed up”.

The temperature sensor 33 (e.g., the thermistor) is mounted in the operation (heating) area of each evaporator 2 (over each main coil 7), the sensor avoids overheating by restricting the power, if the temperature exceeds allowable limits. The adjustment is conducted by PID-controlling (between the microcontroller 25 and the transistor module 28 for controlling the powering and the operation of the evaporators 2).

In order to generate the thick fog “S” (FIG. 7), it is required to “stir” it (i.e., the fog) with the air “A” during evaporation (FIG. 7), as well as to create a condition to avoid the liquid (f) to be evaporated from returning back by condensation after it has been evaporated. To this end, all electrical heating elements 3 of the evaporators 2 are arranged in front of the powerful air flow source that is generated by the air turbine 34 (FIG. 7): a blower or a high-revolution fan depending on the certain configuration of the fog generator 1. The microcontroller 25 controls the operation of the air turbine 34 and, thus, the air flow rate. In order to achieve the maximum performance coefficient, the flow from the air turbine 34 to the main coils 7 and to the additional winding 9 of the electrical heating elements 3 is formed by the special exhaust 35 (FIG. 7) that has smoothed shapes inside and guides the air flow to the fog generation source directly. Also, the air turbine 34 forms a direction of the flow “A” of the formed fog “S”.

The microcontroller 25 has the corresponding (customized) uploaded and installed software in the form of data and source codes.

The microcontroller 25, the pump 5, the transistor module 28 for controlling the powering and the operation of the evaporators 2 and the air turbine 34 are connected to the power connector 26 and, thus, they are powered.

The evaporators 2 are connected to the power supply and powered via the transistor module 28. Thus, the microcontroller 25 controls the operation of the transistor module 28 (as well as the operation and powering of the evaporators 2). The microcontroller 25 controls the operation and powering of the pump 5 via the transistor unit 29. The microcontroller 25 also controls the operation and powering of the air turbine 34 via the transistor unit 30.

The fog sensor 31, the sensor 32 of the liquid (f) to be evaporated and the temperature sensors 33 of the evaporators 2 are connected to the microcontroller 25, and these sensors 31, 32, 33 are powered by the microcontroller 25, and, thus, these sensors 31, 32, 33 provide the following corresponding signals to the microcontroller 25:
about the presence of the fog in the device (the sensor 31);
about the presence/level of the liquid (f) to be evaporated in the main reservoir 4 (the sensor 32);
about the temperature of the main coil 7 with the additional winding 9 of the electrical heating element 3 of the evaporator 2 (the temperature sensor 33); thus temperature sensor 33 is intended to control the temperature of the main coil 7 with the additional winding 9 in order to avoid their overheating.

As it has been already mentioned, the microcontroller 25 must be connected, via the switching connector 27, to other external electronic devices (to other controllers, computer, communication tool, similar tools or appliances, including appliances of a multi-level security system which act as an “external control device”) which perform the following functions as per the corresponding protocol: providing “activation/deactivation” commands; adjusting the fog level; programming/reprogramming of the microcontroller 25; adjusting other parameters.

The fog generator 1 is capable of operating both as an individual security tool in combination with the “external control device” and as a part of the multi-component security system which are used for alarming and security purposes within rooms and/or at other sites.

The proposed fog generator 1 has passed wide tests during its pilot production, as well as during its usage within various rooms.

Results of the tests have demonstrated that the structure of the proposed invention enables to provide the cost-effective, lightweight, small-sized and portable fog generator that is capable of providing the quick and maximum evaporation effect of a certain liquid in order to generate the maximum amount of the fog.

The proposed structure enables to:
increase the effective evaporation area and, thus, to increase the speed of achievement of the evaporation effect and fog generation;
be actuated quickly for the full power within 2-3 seconds after activation and, thus, to receive the required amount of the fog after activation as quickly as possible;
avoid the preliminary continuous (stationary) warm-up of the “evaporator”, and, thus, to avoid the excessive energy consumption by the “evaporator” in the standby mode;
provide the small size (weight and overall dimensions) of the device;
increase the fog generation speed and efficiency, while at the same time providing the energy saving and portability of the device, as a result of all the above-mentioned.

The exemplary specific industrial embodiment of the proposed invention and its usage are mentioned above as the best exemplary embodiment.

The proposed fog generator for the security system meets all the requirements of its use, application, and commonly accepted safety rules regarding use of such security devices.

What is claimed is:

1. A fog generator (1) comprising at least one evaporator (2) that is configured to evaporate a liquid (f) and formed by at least one electrical heating element (3) that contacts with the liquid (f) to be evaporated, and having a power supply connected thereto, a main reservoir (4) for the liquid (f) to be evaporated, a pump (5) that is connected to the main reservoir (4) and to the evaporator (2) so as to pump the liquid (f) to be evaporated from the main reservoir (4) to the evaporator (2), a programmable electronic control unit (6) having a power connector (26) and a switching connector (27) for connecting to other external electronic devices, wherein the at least one electrical heating element (3) is formed as at least one main coil (7) made of a metal wire (8), the coil is winded with an additional winding (9) made of an additional metal wire (10), and the electrical heating element (3) formed by the metal wire (8) and the additional metal wire (10) in the form of the main coil (7) having the additional winding (9) is thermally treated, and a silica wrapping (13) that is made of a fireproof silica filament (14) is arranged around rounds of the coil (7) having the additional winding (9), furthermore, the evaporator (2) comprises a needle-like tube (11) for supplying the liquid (f) to be evaporated, the needle-like tube is cylindrically shaped and comprises a clogged hole on one side and an open hole (16) on another side, and the needle-like tube (11) comprises transverse slots (12), and a total sum of areas of all transverse slots (12) equals to an area of the open hole (16) of the needle-like tube (11), while a portion of the needle-like tube (11) is inserted inside the main coil (7) of the electrical heating element (3) with that portion of the needle-like tube (11) which has the transverse slots (12) and the clogged hole, furthermore, the fog generator (1) comprises a general line (15) having an inner pathway hole (17) for supplying the liquid (f) to be evaporated, and the needle-like tube (11) is inserted with its side provided with the open hole (16) into the general line (15) in such a way that the open hole (16) of the needle-like tube (11) is connected to the inner pathway hole (17) of the general line (15), and an inlet of the pathway hole (17) of the general line (15) is connected to the pump (5), furthermore, an additional reservoir (20) for a remainder of the liquid (f) to be evaporated is mounted under the evaporator (2) and over the main reservoir (4), the additional reservoir is connected to the pump (5), and the additional reservoir (20) and the main reservoir (4) are connected between each other by their own corresponding holes (22) and (23), while a tube (24) that is connected to the additional reservoir (20) is mounted inside the main reservoir (4), furthermore, an air turbine (34) is mounted in front of the electrical heating element (3) of the evaporator (2), furthermore, the programmable electronic control unit (6) comprises: a microcontroller (25) having an uploaded and installed software in a form of a data and source codes, a transistor module (28) for controlling the evaporator (2) powering and operation, a transistor unit (29) for controlling the pump (5) powering and operation, a transistor unit (30) for controlling the air turbine (34) powering and operation; and the fog generator (1) comprises a fog sensor (31) and a sensor (32) of the liquid (f) to be evaporated, while the evaporator (2) comprises a temperature sensor (33), and the microcontroller (25) has established connections to the evaporator (2) via the transistor module (28), to the pump (5) via the transistor unit (29), to the air turbine (34) via the transistor unit (30), to the fog sensor (31), to the sensor (32) of the liquid (f) to be evaporated and to the temperature sensor (33) of the evaporator (2).

2. The fog generator according to claim 1, comprising a plurality of evaporators (2), each formed by a corresponding heating element (3), each having a power supply connected thereto, and each one of the evaporators (2) comprises its own individual temperature sensor (33).

3. The fog generator according to claim 1, comprising four evaporators (2), each formed by a corresponding electrical heating element (3), and the four electrical heating elements (3), in particular, their main coils (7) along with the additional winding (9), are connected pairwise in parallel and then successively or completely successively, or completely in parallel, and the power supply is connected to each of the electrical heating elements (3).

4. The fog generator according to claim 1, wherein the metal wire (8) of the main coil (7) and the additional metal wire (10) of the additional winding (9) are made of a nichrome alloy, and a diameter of the metal wires (8), (10) is ranged from 0.05 mm to 1.00 mm, while a diameter of the rounds of the main coil (7) is ranged from 3 mm to 3.5 mm, and a number of the rounds of the main coil (7) is ranged from seven to twelve.

5. The fog generator according to claim 1, wherein each electrical heating element (3) is made in a form of two or three main coils (7) which are adjacent and arranged “in a row” in parallel, and these parallel main coils (7) has a shared additional winding (9) provided by the additional metal wire (10) such that this electrical heating element (3) has a general “planar” shape.

6. The fog generator according to claim 1, wherein each electrical heating element (3) is made in a form of four or more main coils (7), and this plurality of the main coils (7) has a shared additional winding (9) provided by the additional metal wire (10).

7. The fog generator according to claim 1, wherein the additional winding (9) of the main coil (7) or of the plurality of the main coils (7) is formed by a plurality of additional metal wires (10).

8. The fog generator according to claim 1, wherein the needle-type tube (11) is made of a stainless steel and has a diameter ranged from 2 mm to 3 mm with a thickness of walls being 0.3 mm, and comprises from 12 to 20 transverse slots (12).

9. The fog generator according to claim 1, wherein the fireproof silica filament (14) has a diameter ranged from 0.2 mm to 0.5 mm and is arranged in the silica wrapping (13) in an unsystematic fashion, or the fireproof silica filament (14) is arranged in the silica wrapping (13) perpendicularly relative to the rounds of the main coil (7).

10. The fog generator according to claim 1, wherein the general line (15) for supplying the liquid (f) to be evaporated is made of a metal or a metal alloy, as well as mountable in the general line (15) and configured to enable a connection of a plurality of needle-like tubes (11) of the plurality of the corresponding evaporators (2) to its inner pathway hole (17).

11. The fog generator according to claim 1, wherein the inlet of the pathway hole (17) of the general line (15) is connected to an inlet tube (18) having one side that is connected to a flexible tube (19) which is, in turn, connected to the pump (5), and the inlet tube (18) of the general line (15) is made of a metal or a metal alloy and has a diameter ranged from 3 mm to 4 mm, while the flexible tube (19) is made of a material that is able to withstand a high pressure and a high temperature of at least 220° C.

12. The fog generator according to claim 1, wherein it comprises an exhaust (35) that is mounted and arranged adjacent to the air turbine (34).

13. The fog generator according to claim 2, wherein the microcontroller (25) has established connections to the plurality of the evaporators (2) via the transistor module (28) and has established connections to the corresponding temperature sensors (33).
